(19) United States
(12) Patent Application Publication
(10) Pub. No.: US 2003/0033828 A1
(43) Pub. Date: Feb. 20, 2003

(54) Perpetual unit ice making machine

(76) Inventor: Hubert Melbourne Hensford, York, PA (US)

Correspondence Address: Hubert Melbourne Hensford, 421 South George Street, York, PA, 17403, US

(21) Appl. No.: 10/021,239

(22) Filed: Dec. 19, 2001

Related U.S. Application Data
(63) Continuation of application No. 60/313,064, filed on Aug. 20, 2001.

(51) Int. Cl. A23G 9/00

(52) U.S. Cl. 62/345

(57) ABSTRACT

A redundant ice making machine having a freezing zone and a storage zone. Each zone has a transportation system that carries receptacles along with freezable material in or through each zone, and are connected from the entrance of the zones to the exit of the zones. The two zones are connected by means of an external transportation system that begins at the exit of the freezing zone, and contains a defrost zone, a separation zone and a filling station.

### FIELD OF THE INVENTION

The invention relates to a perpetual system of processing units of freezable materials into units of frozen materials.

### BACKGROUND OF THE INVENTION

The system of the invention have many applications, however, for the purpose of illustration, this invention is focus on industrial application. Today's icemaking systems employs the use of multiple unit discharge. In this manner, multiple units of vertical concave or tubular refrigerated receptacle receive a constant flow of freezable material over their surface. A phase change cause the freezable material to solidify to a desired thickness. A defrost occur and the surfaces between the frozen material and its receptacle rises sufficient enough to cause separation. This system allows for all units to be released at the same time. This release causes the units to collide with each other and release fragments as they free fall to a storage bin below. These fragments which is a reduction in the unit mass is waste products, and must be handled and stored in a refrigerated area. This invention addresses the waste problem and in doing so realized numerous other benefits such as lower refrigeration capacity, less storage facility, less operating, smaller footprint etc.

### BRIEF SUMMARY OF THE INVENTION

In accordance with the invention, there is provided two refrigerated boxes, known as the freezing zone and the storage zone, well insulated with access doors for installation and service, a low temperature conveyor system for transporting the units of frozen materials in the storage zone, freezable materials in their receptacle in the freezing zone, a floor drain for clean-up, an entrance and exit for the said units, a defrost zone, a separation system, a return system, a storage feed system a filling station and receptacles.

The units leaves the separation zone and enters the fill zone. In this zone, sub-cooled freezable material fills the receptacles. This filled receptacle, also known as a unit, enters the freezing zone where it is exposed to a phase change while in motion downward to the exit of the freezing zone. As the unit exits the freezing zone, it is received by the defrost system by which it is exposed to a period of defrost, then travels to the separation zone. In the separation zone, the receptacle is separated from the frozen unit. The frozen unit is directed to the storage zone and the now empty receptacle is directed to the filling station simultaneously. In the storage zone, the frozen unit is stored for future use if the system of the invention is in the intermittent mode, or the unit continues down toward the exit and to a retail area, if the system of the invention is in a perpetual mode.

Some of the advantage of this invention is that the preferred embodiment thereof utilizes far less footprint; Storage occurs within the system and will deliver each unit on demand: Material to product ratio are almost identical: A perpetual or intermittent product delivery: Low noise pollution: less refrigeration capacity; lower operating cost; no waste storage and dispersal; Preferred embodiment allows for dust free environment; state of the art controls.

Still other advantages of the present invention will be apparent during the course of the following detail description taken in connection with the accompanying drawings, forming portions of this disclosure, and in witch drawings:

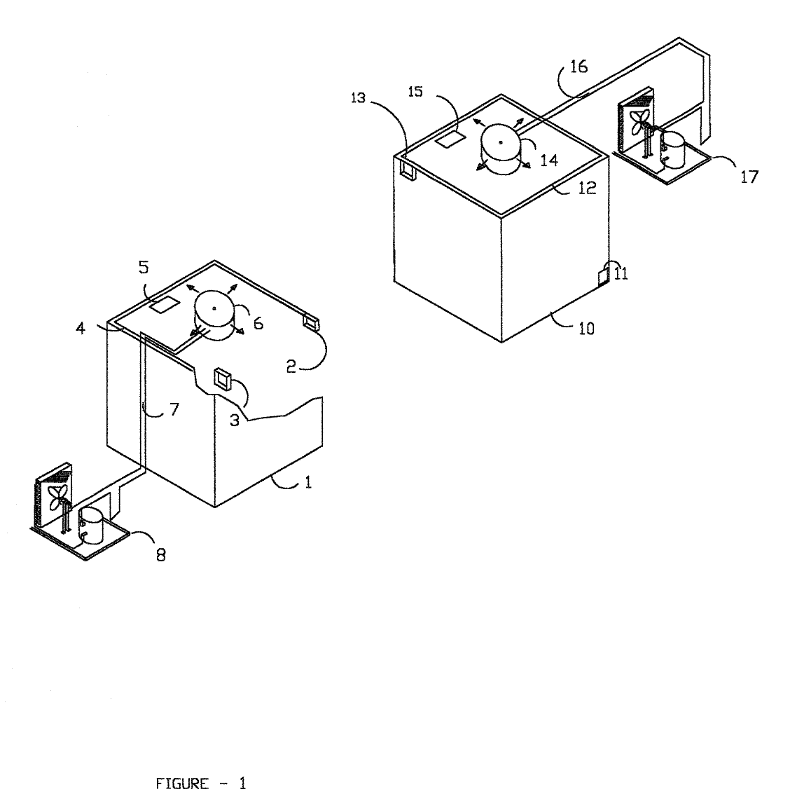

FIG. 1 shows the two major components of the system along with their functional requirements.

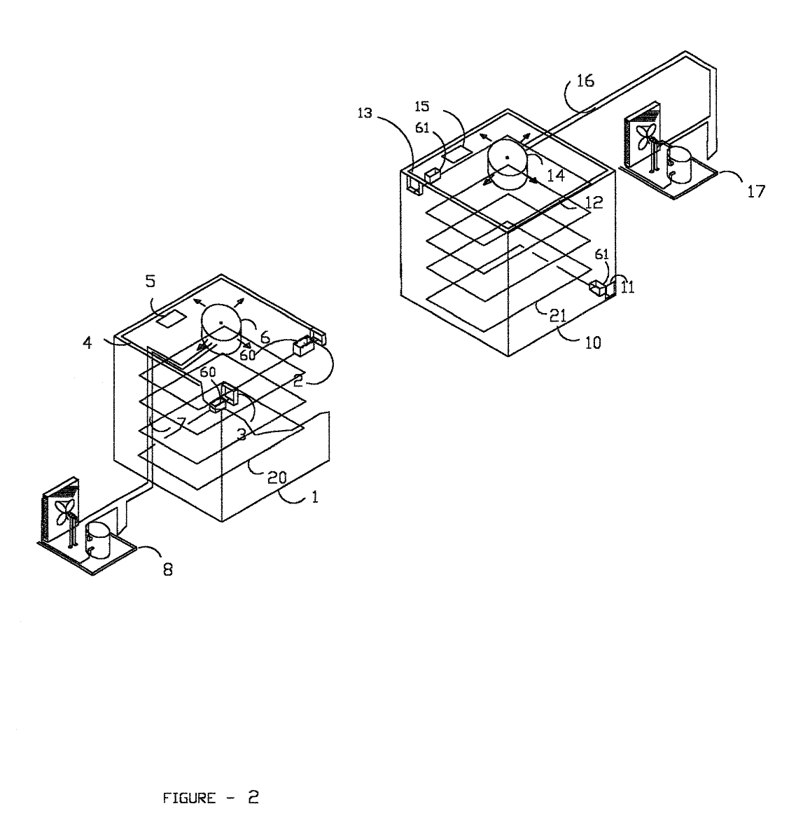

FIG. 2 shows the freezer and storage unit transportation system.

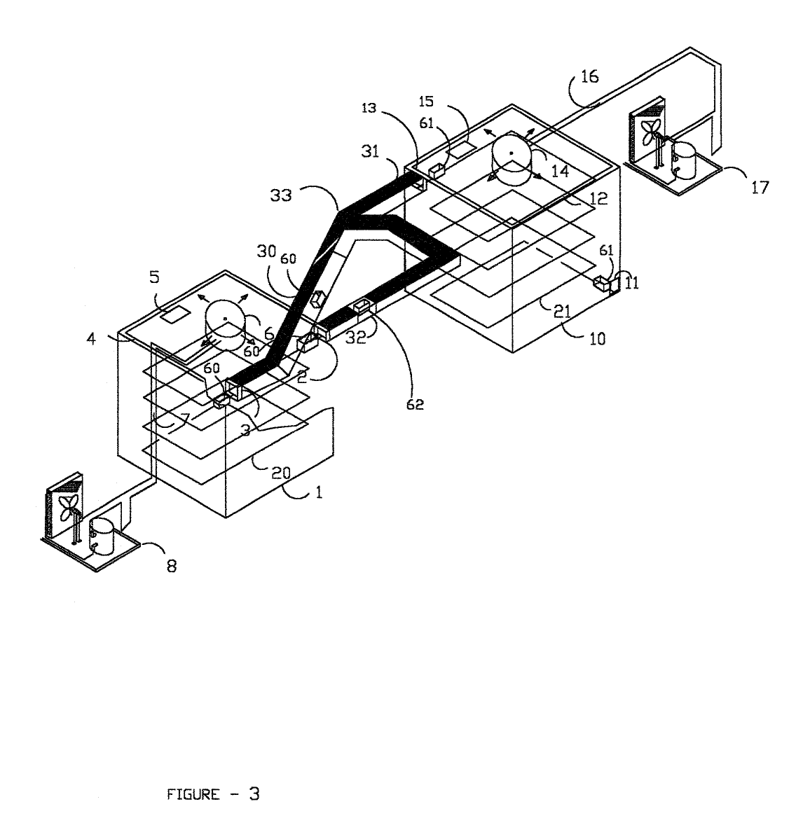

FIG. 3 shows one of many unit transportation, defrost, separation, direction return and fill system that interconnect the two major components.

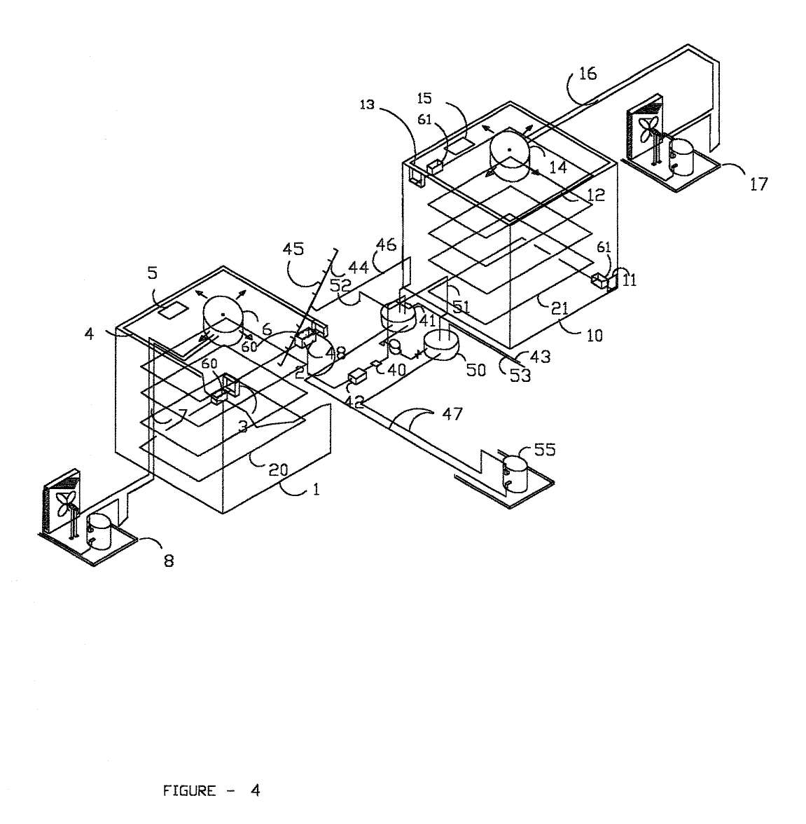

FIG. 4 shows two sub-systems, defrost and sub-cool.

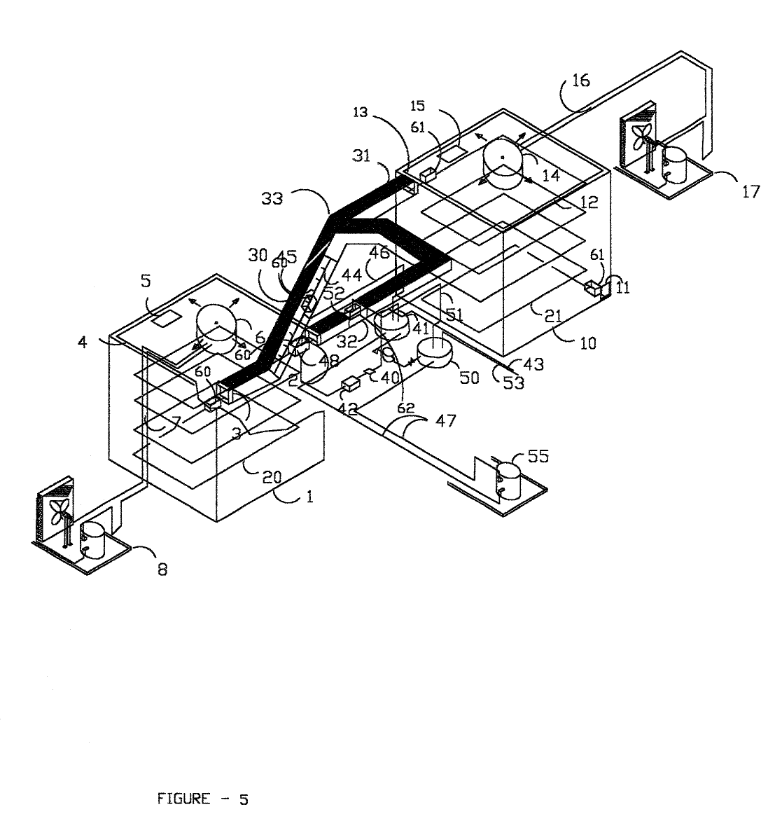

FIG. 5 shows all components of the invention.

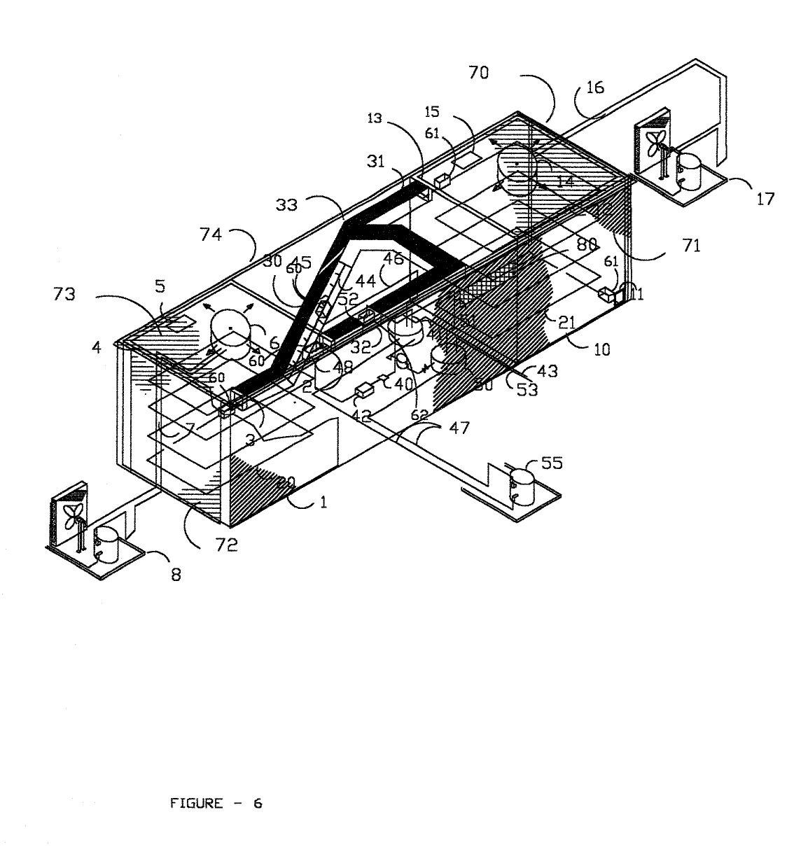

FIG. 6 shows a preferred embodiment.

### DETAIL DESCRIPTION OF A PREFERRED EMBODIMENT OF THE INVENTION

Reference is now made to FIG. 1 which is a representation of the two major components, a freezing zone (1) and a storage zone (10). These zones are essentially walk-in freezers, well known to art. For the system of the invention, these walk-in freezers (1,10) are modified to include unit entrance (2),(13), unit exit (3), (11), fan/coil unit (6),(14), access door (5), (15) and insulated metal walls (4), (12).In The freezing zone (1), the exit (3) location is the lowest corner of the freezer (1) as shown, and its dimensions are determined by receptacle size. The entrance (2) is located at the top opposite corner as shown, and dimensions are determined by receptacle size. In the storage zone (10), the entrance (13) is located at the top corner and the exit (11) is located at the bottom corner as shown. The entrance and exit locations of the storage and freezing zones will become apparent later on. The fan/coil units (6,14) for the two zones (1,10), are known to the arts, and is preferred because it allows air movement in the zones and could establish a pressure if required. The condensing units (8,17) connected to the fan/coil units (6,14) via piping (7,16) is shown in this location for clarity, other remote locations are possible.

FIG. 2 shows the internal transportation systems (20,21) for the freezable material and their receptacle (60) in the freezing zone (1), and the frozen units without their receptacles (61) in the storage zone (10). The beginning of these transportation systems are attached to the entrances of the zones (2,13) and the ends are attached to the exit (2,11). These systems have a determine pitch down from the entrances (2,13) to the exit.

Reference to FIG. 3 is a representation of a connection of the two zones (1,10) via the defrost zone (30), the separation zone (33) and the filling station (32). The defrost zone (30) is an open thoroughfare for each unit (60) on its way to the separation zone (33).

In FIG. 4 the defrost zone (30) consist of a piping system (46) connected to a header (44) and nozzles (45) arranged so as to affect the underside of the receptacle as it journey to the separation zone (33), and are placed at determined distance throughout the length of the defrost zone (30). Distribution header (44) and nozzle (45) can be metallic, plastic or any other material that is found to be suitable. The piping (46) that connect the header (44) is connected to a heat exchanger (41) below. This heat exchanger (41) is either water or air. The heat stored in the exchanger (41) is absorbed from the heat rejected by the sub-cooled condensing unit (55). This water heat exchanger consist of a closed metallic vessel (41) with piping entering at a location close to the top, to allow recalculated and make-up water to enter. Piping (46) that leaves the top of the heat exchanger allow heated water to be discharged to the defrost header (44). A pump (40) in the piping system is connected from a sump (42) to the inlet of the vessel (41). This pump (40) also establishes the working pressure of this defrost system. A sump (42) is located at a low point to collect the now cooled water and direct it back to the heat exchanger (41) to absorb more heat. Hot gas from the sob-cool condensing unit (55) is directed to the heat exchanger (41) and is either passed around the exterior of the vessel (41), or travels through the water in the vessel (41) via tubing.

The separation zone (33) is where the three zone come together. A conveyor system is so configured as to cause the frozen unit to become dislodged and move away from the receptacle (60). There many types of systems available today, so I will not elaborate. The storage zone (10) is identical to the freezing zone (1) in its components except for the unit entrance and exit. Although the physical dimensions are the same as the freezing zone, their location are different as seen in the drawing FIG. 1.

The filling station (32) consist of a nozzle (52), piping (51), a closed metal vessel (50) refrigeration piping (47), in or around the vessel (50), water supply piping (53), a compressor (55) and controls. The filling zone (32) is a dust free area with filling nozzle (52) placed so as to fill each receptacle (62) without spillage. The sub-cooled material, in this case, water, is forced through the vessel (50) that has low temperature vapor from the compressor flowing around or through the vessel (50).

The receptacle (62) is a metal, plastic or other material whose configuration is a result of the separation system. The surface of the receptacle that contacts the conveyor must be designed to increase surface contact, thereby providing stability of each unit, since stability is crucial to the balancing of the system as will become evident later on. Receptacle (62) size is deterring by customer requirement. The quantity of receptacle is also determined by system capacity.

In FIG. 6, the rear panel (74, front panel (71), right panel (70), left panel (72) and top panel (73) represent a preferred embodiment.

From the power source, not shown, with disconnect and safety controls, this machine will operate when an operator depresses a switch for either single or multiple ice discharge.

While the descriptions of operation of portions of the machine have been detailed, for a better understanding thereof the operation of the machine embodies the following: The operator at a remote or local station, request a single unit of ice. A receptacle in the filling station began to receive sub-cooled freezable material until it is filled, while moving toward the entrance of the freezing zone. The unit's appearance at the entrance of the freezing zone signals the freezer conveyor to receive the receptacle, while releasing one unit to the defrost zone. This simulations entrance and exit in the freezing zone ensures maximum design capacities and perpetual motion at all times. The released unit is defrosted. The ice and receptacle are separated. The ice is directed to the storage, while the empty receptacle returns to the filling station. The arrival of the ice at the entrance of the storage zone signals the storage conveyor to receive the new ice unit, while releasing a unit to the operator and stop. If the operator request continuous unit delivery, then the machine will deliver as in the request for one unit, but will not stop.

Various changes could be made to the form of the invention herein shown and described, without departing from the spirit of the invention or the scope of the claims.

What is claimed is:

1. A machine as in FIG. 6, for freezing freezable materials, said machine including a freezing zone, with insulated walls to prevent the surrounding air temperature from influencing the freezer temperature, fan coil unit, preferably in the top center to distribute the conditioned air evenly through the zone, condensing unit with sufficient capacity as to supply and maintain design zone temperature, opening for unit entrance at the upper portion of the box, opening for unit exit at the lower portion of the box, access door, floor drain, and a low temperature conveyor system for transporting the units in and through the freezing zone; a storage zone that is exactly like the freezing zone described herein, except for the location of the unit exit, which is at the bottom front of the machine; a defrost zone utilizing water, air or other, to raise product and container contact surfaces to cause easy separation in the separation zone; a separation zone that separates the product from the receptacle and direct each to their appropriate destination; a fill station that receives the receptacle from the separation zone and fills said receptacle with sub-cooled liquid supplied to it by a sub-system that is a part of the filling zone; an interconnection of the freezing zone exit to the defrost zone, the separation zone, the storage entrance, the filling station and the entrance of the freezing zone.

2. The steps in the method of freezing units of freezable material which steps comprise automatic filling of a receptacle with freezable material at a station; moving said receptacle to a freezing zone long enough to cause a phase change; moving said receptacle to a defrost zone to prepare for separation; moving said receptacle to a separation area that separates the receptacle from the product. The product is directs the storage zone, while the receptacle is directed back to the filling station.

3. A machine according to claim 1 characterized in that to obtain a non stop flow of product, the following sequence of events must occur; step 1, the machine must be energized, when this occurs, the following default conditions go into effect as follows: the freezer and storage systems operates to establish their design operation temperature, the sub-cool and defrost systems operates to establish their design operation temperature. These events could take several hours upon entail start-up. step 2, fill the freezer with receptacles containing freezable material. These receptacles must remain in the freezing zone until all freezable materials are frozen, this should take several hours; step 3, the frozen material is separated and transferred to the storage, while the receptacles are sent to the filling station. When the storage zone is filled with frozen products, the freezing zone is also filled with receptacles and freezable materials as is detailed earlier. Step 4. Allow all freezable materials in the freezing zone to become frozen. Step 1 through step 4 could take as long as 12 to 20 hours depending on the machine size. It is only after step 1 through 4 is completed in the order described above, can the system of the invention be considered charged and in ready for perpetual operation.
